(19) United States
(12) Patent Application Publication
(10) Pub. No.: US 2004/0221817 A1
(43) Pub. Date: Nov. 11, 2004

(54) Remote watering devices

(76) Inventor: Murry Hatfield, Millersview, TX (US)

Correspondence Address: Christopher J. Whewell, Western Patent Group, 6020 Tonkowa Trail, Georgetown, TX, 78628, US

(21) Appl. No.: 10/430,017

(22) Filed: May 6, 2003

(51) Int. Cl. A01K 7/00

(52) U.S. Cl. 119/74

(57) ABSTRACT

Provided herein is a device and process for providing water in remote areas, for access by wildlife so as to encourage their presence in the area, either for aesthetic purposes, for wildlife projects, or for hunting purposes. A device according to the invention, in one embodiment, provides water in such a fashion that the water provided is not directly visible to the targeted wildlife.

### TECHNICAL FIELD

This invention relates to providing water in remote areas. More particularly, it provides a device for providing water to wildlife in remote areas.

### BACKGROUND

Most known life forms require water for their sustainment. The availability of water in a given area is often the determining factor as to whether a particular life form may be found in that particular area. It is thus no surprise that in cases where hunters hunt various wildlife species, game, and the like, it is known that wildlife tends to be found in areas where water is accessible. The converse is also true, that where no water is to be found, the chances of locating game are greatly diminished.

In remote regions such as west Texas where surface water is scarce, there are vast regions where no life is found, particularly birds. However, it is observed that if an open tank of water is placed in a remote area normally devoid of life, that within days many birds can be seen having located the water. Therefore, it is surmised that if a means for continuously supplying water to a remote region were available, the continued presence of certain wildlife can be assured. In such a case, hunters would be assured of a continued presence of their prey.

Various devices have been contrived by those working the art of water delivery, and a few examples from the prior art are now illustrated, the entire contents of each of which are herein incorporated by reference thereto in their entirety.

U.S. Pat. No. 3,965,864 provides an automatic device for rational management of small animals comprising: a) a frame, at least one pair of separate apertured cages for retaining small animals removably mounted on the frame in adjacent spaced locations; b) means for supplying drinking water to the cages; c) means for supplying fodder to the cages including a common fodder supply conveyor mounted in the frame between the cages and having a pair of feed tubes extending therefrom, wherein the feed tubes each include a feeding bowl mounted on the end thereof remote from the conveyor and extending into its associated cage through an aperture in a side wall thereof; and d) means mounted in the frame for receiving and automatically removing dung falling from the cages. Each of the feed bowls have a bottom, side, and top wall. The top wall has an opening through which the animals feed, and the feed tube is connected to and in communication with the feed bowl through the top wall thereof whereby fodder supplied to the bowl through the tubes rises only to the level of the top wall. The bottom wall of the bowl has thin slots formed therein to allow only fodder fines to pass therethrough; and the water supply means includes a water supply valve having an inlet port and an outlet spout formed. There is a valve seat formed between the inlet port and outlet spout, and a valve closure element is mounted in the valve upstream from the seat. There is a spring means for biasing the closure element against the seat to normally close the spout and a control pin secured in the closure element and extending through and beyond the spout to a point where it is exposed for actuation by an animal such that angular movement thereof tilts the closure member and opens the valve;. The valve has a by-pass passage formed therein providing communication between the inlet port and the spout around the closure member. There is an adjusting screw threadably mounted in the valve with an end extending into the passageway for selectively opening and closing the passageway and controlling the flow of water therethrough whereby a small continuous supply of water can pass through the spout when the valve is closed by the closure member.

U.S. Pat. No. 3,984,052 teaches a watering installation, wherein there is a movable carriage provided with a motor element, a front wheel, and at least a nozzle for throwing water. The nozzle is connected to a coupling device on the carriage for coupling the nozzle in sequence to a plurality of water outlet mouths incorporated in a stationary water circuit, which includes a water supply pipe provided with the outlet mouths distributed at spaced points along its length. The carriage comprises guide means for guiding the carriage to follow along with respect to the pipe, and a retractable abutment means mounted on the carriage in a location near to the pipe. The retractable abutment means is positionable into a first position on the carriage for bumping against each of the mouths for stopping the carriage with the coupling device in alignment with the respective mouths. There is an operating means on the carriage for moving the coupling device into a coupling relationship with the aligned mouth, and an actuating means on the carriage for causing the operating means to move the coupling device into engagement with the aligned outlet mouth. There is a holding means for temporarily holding the abutment means in the first position for bumping against the respective outlet mouths. The coupling device includes a release means for releasing the holding means as soon as the coupling device has become engaged with the aligned outlet mouth. The abutment means has a return spring associated therewith for returning the abutment means to the first position, and the abutment means including flexible means which is put under stress when the abutment means bumps against the respective mouths. The stressed flexible means moves the abutment means to a retracted position against the force of the return spring as soon as the holding means has been released, and the holding means is incapable of holding the abutment means in the retracted position.

U.S. Pat. No. 4,015,616 teaches a moisture-sensitive hydroelectrical switch comprising a hollow body having an inlet end, an outlet end, and a dry chamber, an electrical switch, having electrical conduits provided with switch contacts, fastened in the dry chamber, a fluid tight pressure gland, having a medial passageway, rotatively connected to the hollow body at the outlet end with the electrical conduits passing through the medial passageway, a body extension having a hollow core fastened to the inlet end of the hollow body, an adjustable sleeve, provided with an axial passageway, rotatively connected to the body extension, a rod having a head, fabricated from waterproof electrical insulation, slidably mounted in the axial passageway, a peg, fabricated from electrical insulated material, fastened in the head, a hollow sleeve, fabricated from resilient material, interposed between the adjustable sleeve and the head to urge the peg against the switch contacts, a plurality of collars, fabricated from moisture sensitive material, which expands when wet and contracts when drying, fastened to the rod to move the peg toward and away from the switch contacts to open and close the electrical switch.

U.S. Pat. No. 4,023,585 describes a watering device for watering gardens and the like without constant attention. The device has a box-like construction and has an L-shaped passageway therethrough with an inlet and outlet for connection between the sprinkler and a source of water at the opposite ends of the passageway. A solenoid operated valve is mounted in the passageway, with a solenoid upon actuation moving the valve to open the passageway. A timer is mounted on top of the box to actuate the solenoid at a selected hour of the day to thereby allow water to flow through the passageway to the sprinkler for sprinkling, which timer will maintain the solenoid actuated for a selected amount of time. A thermostat is mounted to the top of the box which actuates the solenoid when the temperatures reach the danger of frost (35° F. or below), which solenoid opens the valve and allows water to travel through the passageway to the sprinkler for sprinkling gardens and the like to prevent the frost from damaging produce in the garden.

U.S. Pat. No. 4,138,967 teaches a water supply and control device for animals which includes: a) a water reservoir; b) a water supply pipe extending into the water reservoir; c) a valve mounted on the supply pipe, the valve positioned within the water reservoir and controlling the flow of water through the water pipe; d) an upper float assembly having a movable float element within the water reservoir mechanically linked to open and close the valve; e) a lower float assembly having a float element connected to the end of an arm pivotally connected to a fixed location within the water reservoir; f) a brace member having one end connected to the top side of the arm of the lower float assembly, the opposite end of the brace member engaging restraining means in the upper float assembly, and g) a means between the upper float assembly and the opposite end of the brace to allow the brace to remain in restraining engagement with the upper float assembly until the water within the reservoir falls to a predetermined level. The lower float assembly follows the lowering of the water level until the predetermined level is attained whereby the brace is released from the upper float assembly allowing a fresh supply of water to enter the water reservoir until the upper float assembly shuts off the valve and the brace of the lower float assembly again engages the upper float assembly.

U.S. Pat. No. 4,246,870 provides an automatic drinking-trough for animals for use with a water duct having an aperture through which the water exits comprising: a) a valve adapted to be connected to the duct for controlling the exit of water from the duct; b) a bowl having a bottom portion located below the valve and a rear wall; c) a control member connected to the valve for directly actuating the valve upon movement of the control member in any direction (The control member includes a hollow tube through which the water leaving the valve travels to the end of the tube remote from the valve which is located adjacent both the bottom and the rear of the bowl and from which the water is discharged into the bowl with a reduced amount of splashing); and d) a fixed hood for shielding the valve and a substantial portion of the length of the tube below the valve leaving an exposed portion only adjacent the bottom of the bowl to be contacted by an animal who projects a part of its body into the bowl below the end of the hood to engage the tube and move the control member to open the valve so that the water exits from the end of the tube. The valve is operable to open upon movement of the tube in any direction upon the part of the body of an animal engaging same.

U.S. Pat. No. 4,274,365 sets forth a device for automatically providing controlled amounts of clean, fresh drinking water to livestock, and the like, comprising: a) a basin; b) a trough attached to the basin; c) a partition separating the basin and the trough; d) a slot defined in the partition, wherein the slot establishes fluid communication between the basin and the trough and having side walls which each include a first undulating portion and a second straight portion; e) water supply means fluidly connected to the basin; and f) flow control means fluidly interposed between the water supply means and the basin to control the flow of liquid into the basin from the water supply means. The flow control means includes a body movably mounted in the slot and having a fluid passage defined therethrough, a housing pivotally mounted on the body in the basin, a stopper mounted on the housing to occlude the fluid passage when a water level in the basin reaches a desired level, and a float attached to the housing and located within the basin for sensing the liquid level in the basin and for moving the stopper over the fluid passage to prevent further liquid from entering the basin via the passage when the liquid level in the basin reaches a predetermined level, and for moving the stopper away from the fluid passage when the liquid level in the basin drops below a predetermined level to permit replenishing of the water in the basin and the trough.

U.S. Pat. No. 4,323,036 describes an automatic watering apparatus comprising a central post, means for supporting the post, a sleeve slidably but non-rotatably mounted on the post, a valve assembly, means for mounting the valve assembly on the post, a supply tube for connecting the valve assembly to a water source, the sleeve and the valve assembly is engageable to operate the valve assembly, a bell member rotatably mounted on the sleeve and having a channel for collection of water discharged from the valve assembly, and means for biasing the sleeve and bell member in a direction whereby the valve assembly is operated by the sleeve.

U.S. Pat. No. 4,397,266 teaches an animal watering device having an exterior housing, a water supply pipe disposed in the housing, insulation disposed within the housing about the pipe, and a valve assembly disposed in the outlet portion of the water supply pipe and operatively engageable by an actuator means to supply water to a drinking receptacle disposed beneath the valve assembly, the improvement comprising: a) an insulated apertured bowl shaped float member supported on a free end of the actuator means and substantially overlying the insulated drinking receptacle, wherein the bowl shaped float member floats upon water contained in the drinking receptacle, and the bowl shaped float member is adapted to be moved by direct contact from an animal to introduce water into the interior of the float member, wherein the water may be consumed by the animal from the interior of the insulated apertured bowl shaped float member; and b) the drinking receptacle is further provided with heating means comprising an electrical heating wire surrounded by electrical insulation material, and the drinking receptacle includes an inner metallic bowl to heat the metallic bowl, the metallic bowl transferring heat to water contained within the bowl.

U.S. Pat. No. 4,846,206 discloses an apparatus for dispensing liquid to a plurality of liquid receiving areas. The apparatus comprises: a) a first reservoir means for receiving liquid; b) a first siphon means within the first reservoir means for siphoning liquid from the first reservoir means; c) second reservoir means; d) a means interconnecting the first siphon means to the second reservoir means for enabling flow of liquid from the first reservoir means to the second reservoir means; and e) a second siphon means, including a plurality of siphon tubes within the second reservoir means for enabling flow of liquid therefrom to a number of liquid receiving areas.

U.S. Pat. No. 5,542,605 provides a portable automatic liquid dispensing apparatus for the intermittent dispensing of a controlled volume of liquid, comprising: a) a container adapted to hold a dispensable liquid, thereby defining a liquid level within the container; b) a static flow regulator in fluid communication with the container, the flow regulator is configured to permit a controlled, relatively constant rate of flow of the liquid out of the container which is independent of the liquid level within the container; and c) a timing and dispensing assembly in fluid communication with the flow regulator. The timing and dispensing assembly have a chamber and a siphon tube with an inlet opening and a liquid dispensing port, and is adapted to receive the liquid from the flow regulator and to periodically dispense the liquid from the chamber when a predetermined constant volume of the liquid has accumulated. The inlet opening is in fluid communication with the chamber and the siphon tube permitting intermittent draining of the liquid within the chamber through the liquid dispensing port when the liquid within the chamber has reached a predetermined level.

U.S. Pat. No. 5,782,202 describes a watering dish capable of holding water and debris, the watering dish comprising: a) a valve chamber having a bottom; b) an inlet valve operatively connected to the valve chamber for supplying water to the valve chamber; c) a drinking reservoir adjacent the valve chamber, and d) a partition between the valve chamber and the drinking reservoir. The partition has an aperture therein for providing fluid communication between the valve chamber and the drinking reservoir. The bottom of the valve chamber is sloped toward the drinking reservoir. The aperture extends to the bottom of the valve chamber for allowing the debris in the valve chamber to pass to the drinking reservoir. The inlet valve has an inlet channel for directing the water toward the bottom of the valve chamber for washing the debris out of the valve chamber. The valve chamber has a notch for receiving the inlet valve, and the inlet valve and the valve chamber further have interacting tab means and opening means for slidably receiving the inlet valve during assembly and for securely holding the inlet valve in a unique, predetermined orientation in the notch.

U.S. Pat. No. 5,782,035 teaches a multi-purpose automatic filing basin for containing a selected amount of water which is used for various purposes. The water may be transferred from the basin by wicks or by a pump to water using devices such as plant pots or toys or may be provided for direct use from the basin for devices such as animal feeders and habitats. The basin is kept supplied with water from a pressurized source by a specialized valve which opens in response to a drop in water level below a first selected level and closes in response to the water level reaching a second selected level.

U.S. Pat. No. 6,259,955 provides an electronic control unit comprising an electronic circuit with a programmable processing unit and operating buttons to execute and to vary manually the programming of the processing unit and a display for the visualization of the programming stages. The programmable processing unit is organized to individuate a programming menu that is subdivided into a plurality of parts selectionable at will. Each part comprises at least one chapter. The chapter is formed of at least one setting page of at least one respective programming parameter, and in that each part of the menu is directly selectionable by pressure on at least one respective operating button.

U.S. Pat. No. 6,253,709 sets forth an automatic pet watering device installed on the toilet bowl of a conventional toilet, consisting of a conventional toilet bowl having a top cap connected to an outlet for releasing water, a hollow tube extending from the top cap and above the water line and through the toilet bowl and having an end portion bent in a downward position, a water bowl located near the toilet bowl below the hollow tube, the water bowl having an open end and a bottom end, the first end of the water tube connected to the bottom of the water bowl and extending vertically and connected through the toilet bowl and bent downwardly to a point below the water line of the toilet bowl.

U.S. Pat. No. 6,312,191 describes a self-contained ecological watering system, protected against obturations, and capable of irrigating at low cost uniformly and regularly a variety of cultivated areas; the system operates automatically a series of fertirrigation cycles requiring minimum actuation power and reduced water flow rate. The system permits implementation of various configuration including a plurality of local subsystems (1) which are controllable locally or from a remote station (6); each subsystem comprises a container (2) capable of accumulating the volume of liquid to be discharged per cycle, a watering assembly (3) capable of regulating the watering volume and discharging it upon receiving a low power signal; a low consumption electronic control unit (4) capable of determining the frequency and the appropriate time to send the signal; and a low restriction distribution network (5) capable of transporting the water to irrigate the locations in need.

However, I have observed that the various devices of the prior art enable watering of all animal species without discrimination, which translates to increased consumption of the water by undesired species at the expense of the desired species, which inherently necessitates a more frequent re-filling of the storage tank than would otherwise be necessary. In addition, evaporation of water leads to an increase in re-filling frequency. Therefore, a need exists for continuously ensuring a source of water for desired wildlife which does not suffer the great evaporative and other losses which prior art devices are prone to.

### SUMMARY OF THE INVENTION

In one preferred embodiment, the present invention provides a device useful for dispensing water to wildlife, including small game and birds such as quail, in remote locations which comprises: a) a storage tank means for storing water, wherein the tank comprises an inlet orifice and an outlet conduit; b) electrical storage means; c) a trough; d) a liquid pump having a pump inlet and a pump outlet, wherein said pump inlet comprises a conduit that is in fluid contact with said storage tank, and wherein said pump outlet comprises a conduit which discharges into said trough; e) means for communicating electrical energy from said electrical storage means to said liquid pump; and f) a cover portion. The cover portion is shaped substantially in the form of a semi-cylindrical shell having a curved upper surface, a flat lower perimeter, a first end portion, and a second end portion. The cover portion is disposed over and encloses the space above said liquid pump and the trough with respect to the external surroundings of the device. The cover portion includes at least one cutout void, which void provides entry access to wildlife desiring to obtain water from the trough disposed within the cover portion, and one or more cutout voids ares located on the lower perimeter of the cover portion.

### BRIEF DESCRIPTION OF THE DRAWINGS

FIG. 1 shows a perspective view of a remote watering device according to the invention;

FIG. 2 shows a side view of a remote watering device according to the invention;

FIG. 3 shows a side of a remote watering device according to the invention with is front cover portion removed to expose the inner elements of the device;

FIG. 4 shows an overhead view of a remote watering device according to the invention with is front cover portion removed to expose the inner elements of the device; and

FIG. 5 shows an end view of a remote watering device according to the invention, as shown from the end which is accessible to wildlife.

FIG. 6 is a perspective view of the semi-cylindrical shell cover portion of a device according to one form of the invention;

FIG. 7 is an underside view of the semi-cylindrical shell cover portion of a device according to one form of the invention; and

FIG. 8 is a perspective view of a cover portion according to an alternate form of the invention.

### DETAILED DESCRIPTION

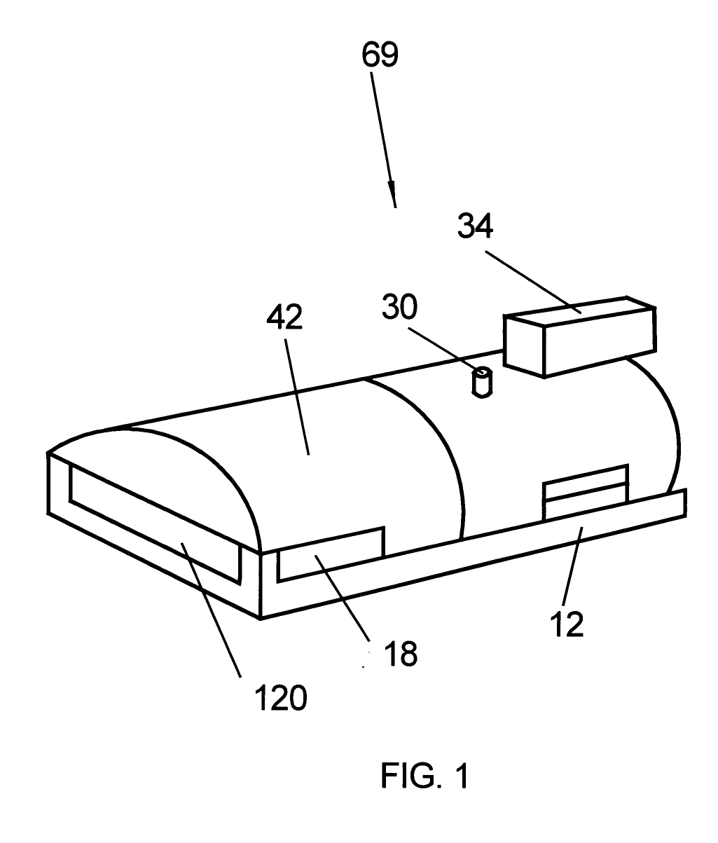

Referring to the drawings and initially to FIG. 1 there is shown a perspective view of a remote watering device 69 according to the invention. In this figure is shown the storage tank means 32, which functions as a reservoir to store water which is to be dispensed at time intervals according to one preferred form of the invention. The storage tank means includes a tank inlet orifice 30, through which the tank may be filled with water.

There is an electrical storage means 34, which is preferably disposed atop the storage tank means 32 for easy access. The electrical storage means 34 may be any conventional electrical storage means such as a battery or capacitor. The present invention is not limited in its scope with respect to the type of electrical storage means, and contemplates the employment of all electrical storage means known to those skilled in the art, including without limitation rechargeable batteries such as nickel-cadmium, lithium ion, lead-acid batteries, etc. According to a preferred form of the invention, the electrical storage means comprises a lead-acid battery of the type commonly employed in automobiles. According to another preferred form of the invention, the electrical storage means comprises a re-chargeable 12-volt gel-cell.

There is a cover portion 42, which serves as an enclosure for the various elements of the invention which are disposed within its confines. The cover portion includes cutout voids 18 and 120, which serve as access holes in the final assembly for small game, including without limitation quail, to enter the confines of the enclosure for access to water contained in the trough element of the invention, as later described.

According to one form of the invention, the storage tank means 32 is maintained in position with respect to the cover portion 42 by means of a rectangularly-shaped base frame comprising a rail 12 which circumscribes the entire device, wherein the cover portion and storage tank are attached to the frame using conventional means such as screws, rivets, welds, etc. In one preferred form of the invention, the frame comprises angle iron, although any rigid material is functionally equivalent, including aluminum, various woods, and composites such as fiberglass or graphite composites. The cover means is preferably comprised of sheet steel, sheet aluminum, or polypropylene.

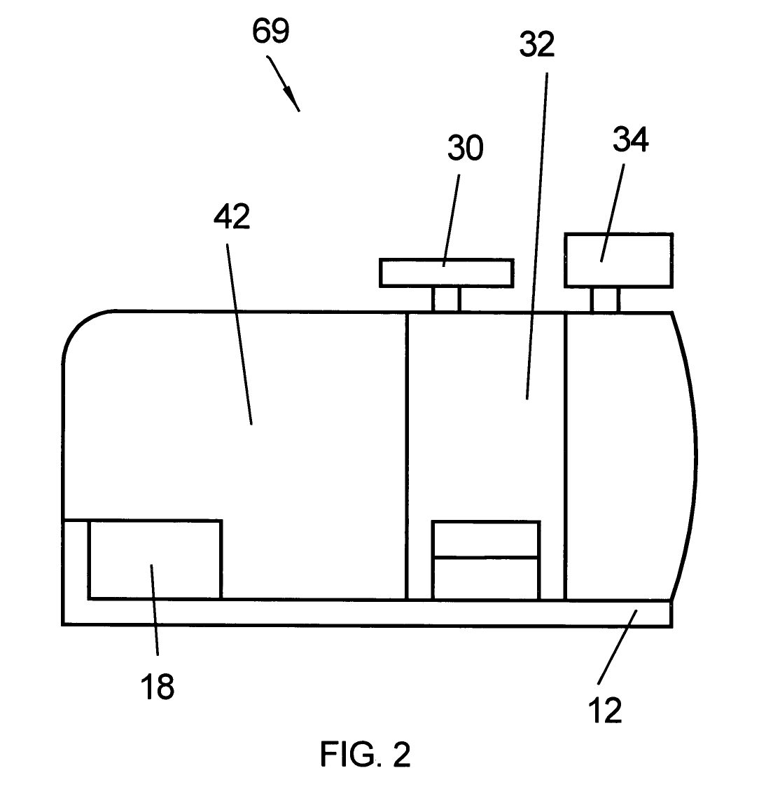

FIG. 2 shows a side view of a remote watering device 69 according to the invention, including the cutout void 18, cover means 42, storage tank 32, frame rail 12, and electrical storage means 34.

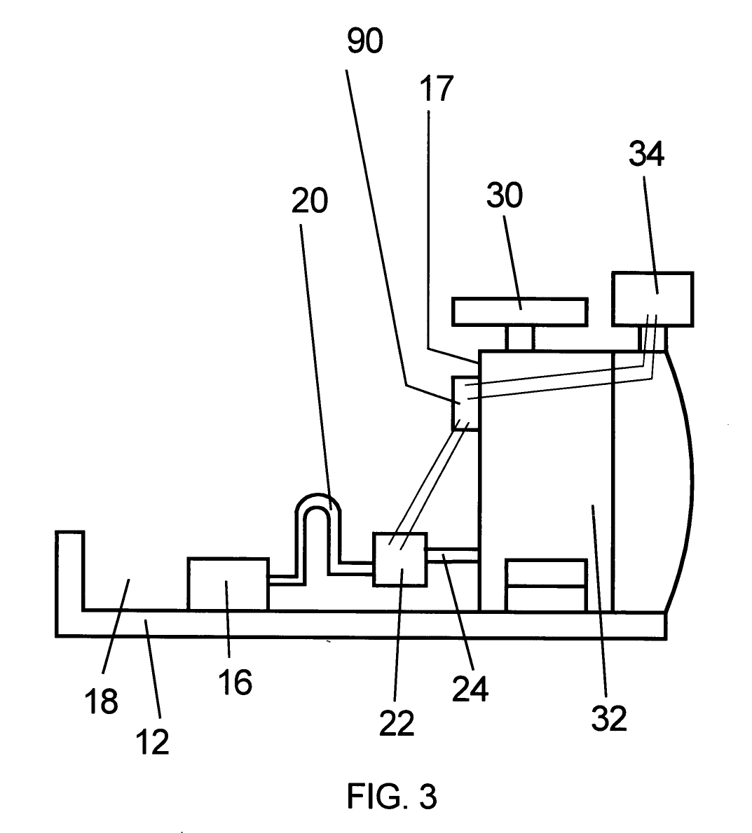

FIG. 3 shows a side of a remote watering device according to the invention with the cover portion removed to expose the inner elements of the device, including the location of the cutout void 18, storage tank 32, frame rail 12, electrical storage means 34, pump 22, pump inlet conduit 24, pump outlet conduit 20, and trough 16. The pump 22 is a fluid pump of any type capable of transferring liquids, such as a rotary vane pump, although pumps with other impellers known in the art are functionally equivalent for the present invention. The pump 22 is electrically actuated, and derives energy for its use from the electrical storage means 34 via wires. According to a preferred form of the invention, the pump is of the type Atwood A500 model 4240 Atwood Corporation of Lowell, Mich. and having a capacity of 500 gallons per hour. According to a preferred form of the invention, there is a programmable timer means 90 electronically disposed between the electrical storage means 34 and the pump 22, which serves to control the periodic timing and duration of energization of the pump 22. The timer means may be disposed in any convenient location, provided that it is electronically disposed between the pump and electrical storage means. According to one preferred form of the invention, the timing means is a REMINGTON® 24DT premium timer unit available from BA Products of Kerrville, Tex., however, and functionally equivalent timer means is suitable for use in the present invention. In one preferred embodiment, the timer means 90 is set to energize the pump once every day for a duration of 30 seconds. However, the times at which the pump is energized may be selected by the user to be varied in accordance with the climate in the field and with the desires of the user. In another embodiment, the pump is energized twice per day for a duration of 20 seconds at each energization. In the former embodiment, the electrical storage means remains effective in excess of 6 months. This embodiment is especially useful in the terrain of West Texas for providing water for quail which are to be hunted.

According to one preferred form of the invention, the pump outlet conduit includes a vertical loop in its path of passage, to prevent the entire contents of the storage tank from draining under the influence of gravity.

The pump outlet conduit 20 discharges into the trough 16, which in one preferred form of the invention is a rectangular tank having an open top which renders its contents accessible for drinking purposes to wildlife which have entered into the enclosed space defined by the cover 42 by means of a cutout such as 18.

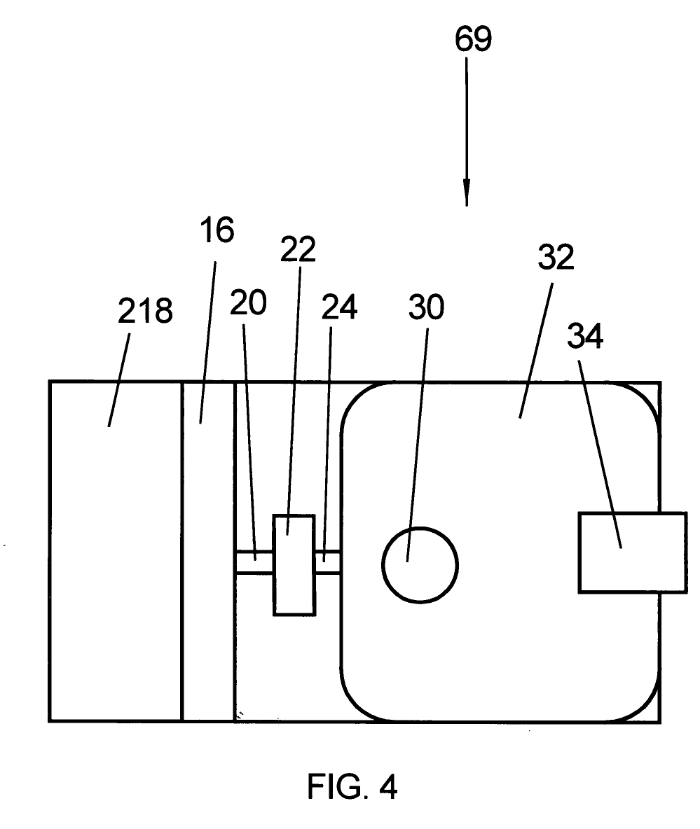

FIG. 4 shows an overhead view of a remote watering device according to the invention with is cover portion 42 removed to expose the inner elements of the device. Shown here are the respective positions of the various elements, including the electrical storage means 34, storage tank 32, tank inlet orifice 30, pump inlet conduit 24, pump 22, pump outlet conduit 20, trough 16, and watering area 218, which watering area is the location within the inner confines of the enclosure defined by the frame, tank wall 17, and cover means 42 at which wildlife can stand while obtaining water from the trough 16.

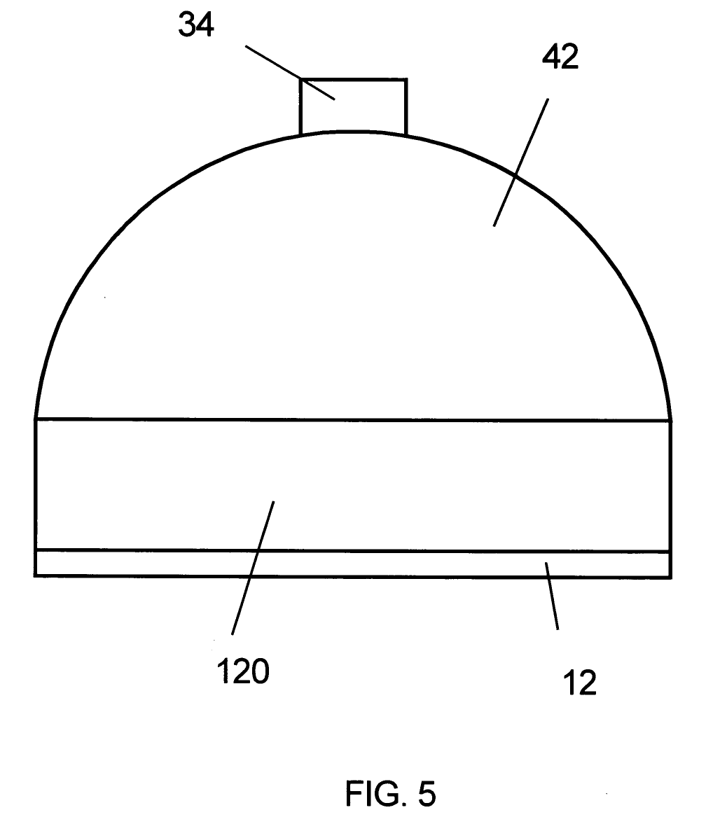

FIG. 5 shows an end view of a remote watering device according to the invention showing the frame 12, cover portion 42, cutout void 120, and electrical storage means 34.

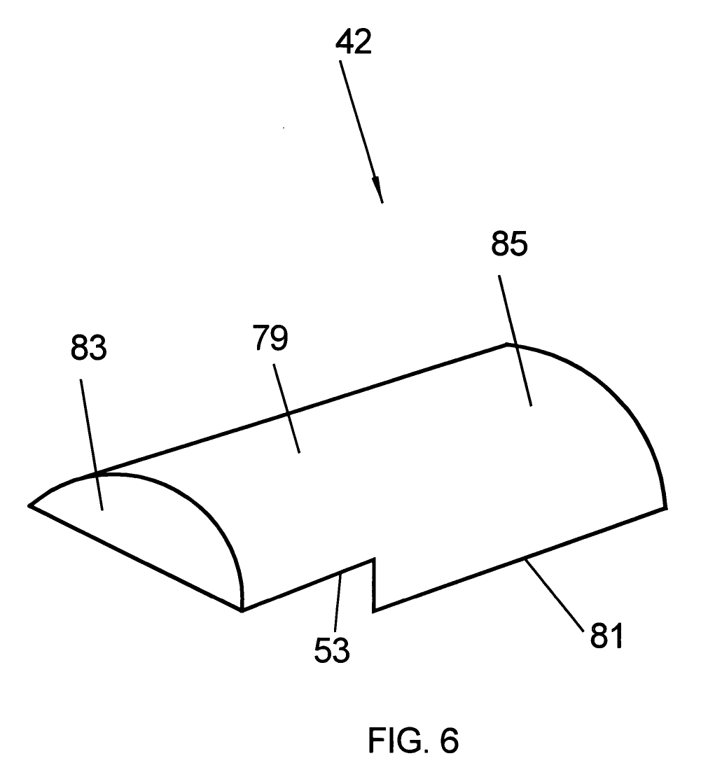

FIG. 6 is a perspective view of the shell cover portion of a device according to one form of the invention showing its upper surface 79, which in one form of the invention the cover portion is semi-cylindrical having a curved upper portion. According to one form of the invention, the cover 42 has a lower perimeter which includes edges 81 and 53, which are parallel to one another and define a cutout void by their being offset from one another. There is a flat end portion 83, and a corresponding identical flat end portion 85 at the other end of the cover 42.

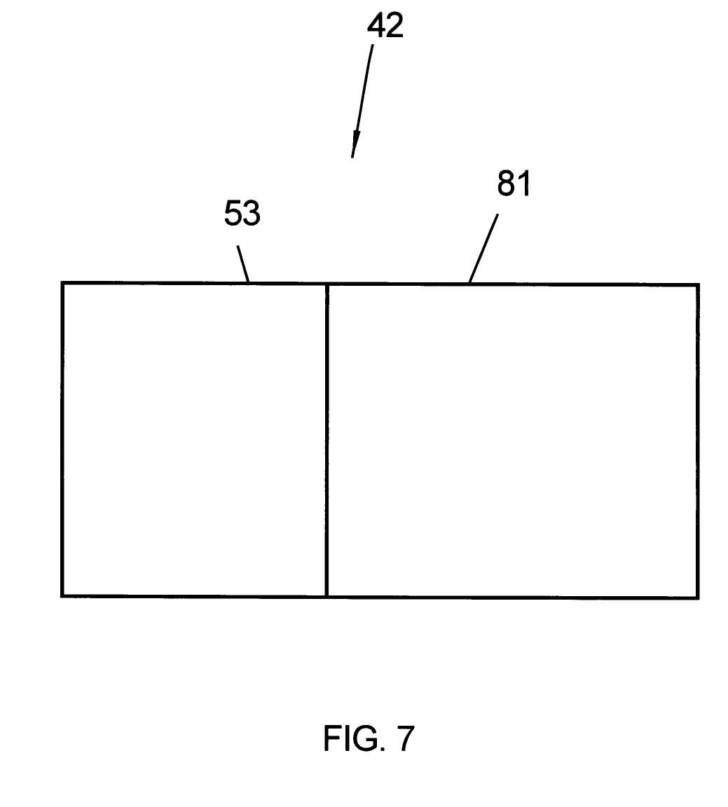

FIG. 7 is an underside view of the semi-cylindrical shell cover portion of a device according to the form of the invention as shown in FIG. 6, showing the perimeter of the underside of the cover portion 42 as being substantially rectangular in this embodiment. It is seen that the portion beneath the cover 42 which exists along the length of the edge 53 defines an overhang.

Thus, the present invention comprises a device useful for providing water to wildlife in remote areas, which comprises an electrical storage means, a liquid storage tank, an electrically-actuated fluid pump having an inlet conduit in fluid contact with the storage tank and an outlet conduit which discharges into a trough, a timer means for programmably energizing the pump so as to fill the trough, wherein the pump, pump inlet conduit, pump outlet conduit, and trough are all enclosed within the confines of a cover means and the wall of the storage tank, which cover includes an upper surface and a lower perimeter and wherein the lower perimeter is formed so as to include a cutout portion that enables wildlife from surrounding areas to gain access to water contained within the trough by entering the void defined by the cutout portion, and wherein the lowermost extremity of the cutout portion is defined by either the frame of the device, or by the ground itself, as in the case when the frame does not extend beneath the overhang portion of the cover.

The invention also provides a device useful for providing water to wildlife in remote areas, which comprises an electrical storage means, a liquid storage tank, a cover portion, an electrically-actuated fluid pump having an inlet conduit in fluid contact with the storage tank and an outlet conduit which discharges into a trough, a timer means for programmably energizing the pump so as to fill the trough, wherein the pump, pump inlet conduit, pump outlet conduit, and trough are all contained within the confines of a volume defined by the inner surface of the cover portion, and the wall of the storage tank, wherein the cover includes an upper surface and a lower perimeter and wherein the lower perimeter of the cover is formed so as to include a cutout portion that enables wildlife from surrounding areas to gain access to water contained within the trough by entering the confines of an area defined by the inner surface of the cover portion, the wall of the storage tank and the ground upon which the device rests or a flat piece of sheet metal beneath the device as a whole, by means of the void defined by the cutout portion, and wherein the lowermost extremity of the cutout portion is defined by a planar surface selected from the group consisting of: the frame of the device and the ground upon which the device rests.

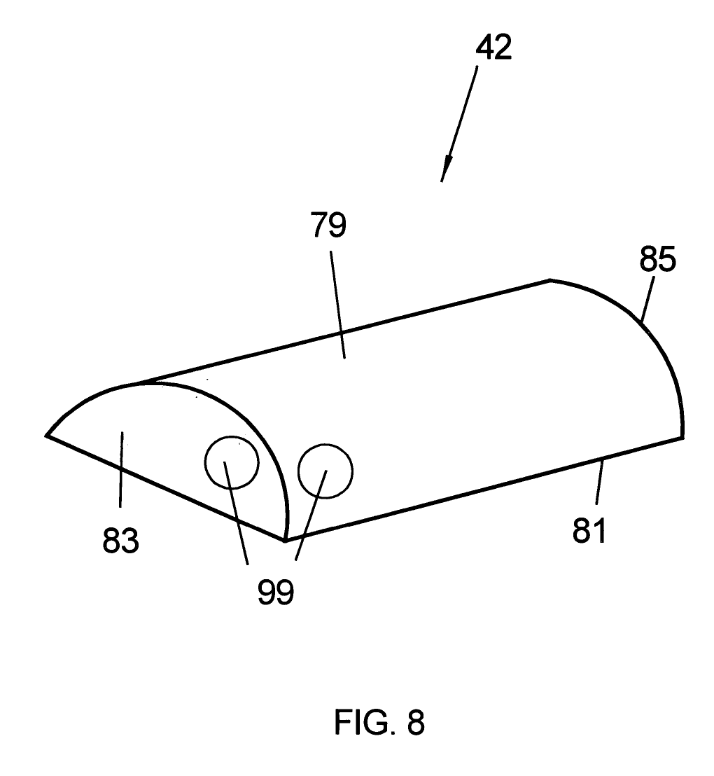

In FIG. 8 is shown the cover portion according to an alternate form of the invention, having one or more holes 99 disposed through its surface. The invention includes those embodiments which include a plurality of such holes in any number and of any size and shape.

A device useful for providing water to wildlife in remote areas, which comprises an electrical storage means, a liquid storage tank, a cover portion, an electrically-actuated fluid pump having an inlet conduit in fluid contact with the storage tank and an outlet conduit which discharges into a trough, a timer means for programmably energizing the pump so as to fill the trough, wherein the pump, pump inlet conduit, pump outlet conduit, and trough are all contained within the confines of a volume defined by the inner surface of the cover portion, and the wall of the storage tank, wherein the cover includes one or more holes disposed through its surface that enable wildlife from surrounding areas to gain access to water contained within the trough by entering the confines of the volume defined by the inner surface of the cover portion and the wall of the storage tank by means of the one or more holes. The size of the holes may be custom-tailored to enable certain desired species to enter while precluding others, based on size.

A cover 42 according to the invention may also have a flat or pointed top surface.

An inherent feature of a device according to the present invention is that the water contained in the trough 16 is not in direct eyesight of a person or animal (and hence is not directly visible) who is looking at the device. Therefore, for species which rely on sight alone, such species do not recognize the instant device as a source of water. I have discovered unexpectedly that birds such as quail and other species do not require a direct eye contact with a water source to recognize it as such, by placing my device in a remote region of the desert and observing many birds having recognized that water was contained within the trough that was obscured from view by the cover portion. This discovery was much to my amazement and is an unexpected basis for success of the present invention with respect to not enabling other life forms which rely upon direct eye contact with water sources for identification of its presence to drink from my device, thus relieving the necessity of frequent re-filling of the storage tank. I do not understand how the birds know water is in there, but it is indisputable that they do, as the present invention has led to my great success in hunting birds in remote areas.

Therefore, the present invention also includes a process for providing water to birds which comprises providing water in an open tank in a remote location, and providing an effective shrouding means so as to render said water not directly viewable to an observer, wherein the shrouding means includes one or more holes through which birds may gain access to the water within the tank. Such a process includes embodiments wherein the tank is periodically refilled by means of the discharge of an electrically-actuated fluid pump operated by a timer, wherein the pump includes an inlet conduit which is in fluid with a water storage tank.

The present invention contemplates the use of the various devices disclosed herein as bait to be used in a trap.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto.

Accordingly, the presently disclosed invention is intended to cover all such modifications and alterations, and is limited only by the scope of the claims which follow.

1) A device useful for dispensing water to wildlife in remote locations which comprises:
a) a storage tank means for storing water, said tank comprising an inlet orifice and an outlet conduit;
b) electrical storage means;
c) a trough;
d) a liquid pump having a pump inlet and a pump outlet, wherein said pump inlet comprises a conduit that is in fluid contact with said storage tank, and wherein said pump outlet comprises a conduit which discharges into said trough;
e) means for communicating electrical energy from said electrical storage means to said liquid pump; and
f) a cover portion,
wherein said cover portion is shaped substantially in the form of a shell having an upper surface, a flat lower perimeter, a first end portion, and a second end portion, and wherein said cover portion is disposed over and encloses the space above said liquid pump and said trough with respect to the external surroundings of said device, and wherein said cover portion includes at least one cutout void, which void provides entry access to wildlife desiring to obtain water from said trough disposed within said cover portion, wherein said cutout void is located on the lower perimeter of said cover portion.

2) A device according to claim 1 wherein water contained within said trough is not visible to an observer external to the device.

3) A watering device according to claim 1 wherein said cutout void is disposed at one of either the first end portion or the second end portion of said cover portion.

4) A watering device according to claim 1 wherein said means for communicating electrical energy from said electrical storage means comprises a timer means.

5) A watering device as in claim 1 wherein said device is substantially rectangular as viewed from above, and wherein said trough is substantially rectangular and has a length, width, and height dimension, and wherein said trough is disposed so that its length dimension is perpendicular to the length dimension of said device as a whole.

6) A device according to claim 1 wherein said cover portion is shaped substantially in the form of a semi-cylindrical shell having a curved upper surface.

7) A device useful for providing water to wildlife in remote areas, which comprises an electrical storage means, a liquid storage tank having a wall, a cover portion having an inner surface, an electrically-actuated fluid pump having an inlet conduit in fluid contact with the storage tank and an outlet conduit which discharges into a trough, a timer means for programmably energizing the pump so as to fill the trough, wherein the pump, pump inlet conduit, pump outlet conduit, and trough are all contained within the confines of a volume defined by the inner surface of the cover portion, and the wall of the storage tank, wherein the cover includes an upper surface and a lower perimeter and wherein the lower perimeter of the cover is formed so as to include a cutout portion that enables wildlife from surrounding areas to gain access to water contained within the trough by entering the confines of an area defined by the inner surface of the cover portion, and the wall of the storage tank by means of the void defined by the cutout portion, and wherein the lowermost extremity of the cutout portion is defined by a planar surface selected from the group consisting of: the frame of the device and the ground upon which the device rests.

8) A device according to claim 7 wherein water contained within said trough is not visible to an observer external to the device.

9) A device according to claim 7 wherein said cover portion is shaped substantially in the form of a semi-cylindrical shell having a curved upper surface.

10) A device useful for providing water to wildlife in remote areas, which comprises an electrical storage means, a liquid storage tank, a cover portion, an electrically-actuated fluid pump having an inlet conduit in fluid contact with the storage tank and an outlet conduit which discharges into a trough, a timer means for programmably energizing the pump so as to fill the trough, wherein the pump, pump inlet conduit, pump outlet conduit, and trough are all contained within the confines of a volume defined by the inner surface of the cover portion, and the wall of the storage tank, wherein the cover includes one or more holes disposed through its surface that enable wildlife from surrounding areas to gain access to water contained within the trough by entering the confines of the volume defined by the inner surface of the cover portion and the wall of the storage tank by means of the one or more holes.

11) A device according to claim 1 wherein water contained within said trough is not visible to an observer external to the device.

12) A device according to claim 10 wherein said cover portion is shaped substantially in the form of a semi-cylindrical shell having a curved upper surface.

13) A process for providing water to birds which comprises providing water in an open tank in a remote location, and providing an effective shrouding means so as to render said water not directly viewable to an observer, wherein the shrouding means includes one or more holes through which birds may gain access to the water within the tank.

14) A process according to claim 13 wherein the tank is periodically refilled by means of the discharge of an electrically-actuated fluid pump operated by a timer, wherein the pump includes an inlet conduit which is in fluid with water contained within a water storage tank.
